(19) United States
(12) Patent Application Publication
(10) Pub. No.: US 2022/0316878 A1
(43) Pub. Date: Oct. 6, 2022

(54) Laser Alignment Tool

(71) Applicant: Jewett Lake Ventures, LLC, Fergus Falls, MN (US)

(72) Inventor: Gary J. Bellikka, Battle Ground, WA (US)

(73) Assignee: Jewett Lake Ventures, LLC

(21) Appl. No.: 17/219,139

(22) Filed: Mar. 31, 2021

(51) Int. Cl. G01C 15/00

(52) U.S. Cl. CPC G01C 15/004

(57) ABSTRACT

A laser alignment tool for projecting a laser spot onto a target object for alignment purposes. The laser alignment tool generally includes a tool body having a rear surface that is normal to a central axis of the laser alignment tool, a laser emitter mounted on the tool body such that the laser emitter projects a laser beam along the central axis of the laser alignment tool, and a centering element on the tool body adapted to position the laser alignment tool on an end of an elongated member such that an axis of the elongated member is substantially coaxial with the central axis of the laser alignment tool.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a laser alignment tool for projecting a laser spot onto a surface, wherein the laser spot is projected along an axis of a pipe or elongated member on which the tool is positioned.

### Related Art

Any discussion of the related art throughout the specification should in no way be considered as an admission that such related art is widely known or forms part of common general knowledge in the field.

Laser tools that are useful for construction practices have been in use for a number of years, and they are generally used for projecting level lines or spots onto walls. For example, some laser devices are made for mounting on flat surfaces, and project vertical or horizontal lines from where they are mounted. In some devices, internal leveling mechanisms have been used to generate such horizontal or vertical lines on walls, etc., but do so without taking account of where the mounting surface is. However, such laser alignment tools are not made to project a laser beam that is an aligned extension of an elongated member or pipe.

### SUMMARY

An example embodiment is directed to a laser alignment tool. The laser alignment tool is useful for projecting a laser spot onto a target object, and may include a tool body having a rear surface that is normal to a central axis of the laser alignment tool, a laser emitter mounted on the tool body such that the laser emitter projects a laser beam along the central axis of the laser alignment tool, and a centering element on the tool body adapted to securely position the laser alignment tool near an end of an elongated member (either directly or by use of a fitting, coupling, etc., on the end of the elongated member) such that an axis of the elongated member is substantially coaxial with the central axis of the laser alignment tool.

In some embodiments, the centering element comprises a ring or a plurality of rings, and the elongated member may be a pipe. If the embodiment includes a plurality of rings, they may be concentric centering elements (e.g., concentric centering rings) and may each further be sized and shaped so that the end of a standard pipe (of various sizes) or a pipe fitting, coupling, etc., fits on one of the rings. Further, the rings may be sized so that a standard sized pipe (such as a standard-size PVC pipe), fitting, or coupling fits on the outside or on the inside of a ring. The concentric rings may be spaced apart from each other, and may extend away from the rear surface of the tool body, and be normal to the rear surface.

In some embodiments, the rear surface of the tool body is adapted to contact a flat surface of the elongated member, pipe, fitting, or coupling that is near the end of the elongated member or pipe such that the central axis of the laser alignment tool is normal to the flat surface of the member or pipe. Accordingly, both the laser and the central axis of the alignment tool will be aligned with the longitudinal axis of the elongated member or pipe. Example fittings may include repair couplings or reducing couplings, “tee” fittings, etc.

In another embodiment of the laser alignment tool, the centering element can comprise an annular groove, or a plurality of concentric annular grooves formed as part of the rear surface of the tool body. In other words, each annular groove may have a bottom surface that is parallel to the rear portion of the tool body, so that, for alignment purposes, both the rear portion of the tool body and the bottom of one or more annular rings comprise a rear surface. When a pipe or other member is positioned so that its terminal end or flat surface rests on the rear surface of the tool, and when the tool is centered on the elongated member or pipe by an annular groove or other centering element, the axis of the pipe will be aligned with the axis of the tool. As noted, the elongated member may be a pipe, and the flat surface of the pipe (at its end) may be annular.

In another embodiment of the laser alignment tool, the centering element can comprise an annular groove, ring, or a plurality of concentric annular grooves or rings as described above, sized so that a standard-sized fitting or adapter on the end of a pipe with fit securely on the centering element.

Any embodiments of the laser alignment tool may also comprise a first level mounted on the tool body to indicate a level condition when the central axis is horizontal. Embodiments may also comprise a second level mounted on the tool body to indicate a level condition when the central axis is vertical.

Further, some embodiments comprise methods of using the laser alignment tool, comprising: activating the laser emitter so that a laser spot is projected onto a target object; positioning the laser alignment tool near the end of the elongated member such that the laser beam is projected along the axis of the elongated member, positioning the elongated member so that the first level indicates that the central axis is horizontal, and marking the spot on the target object. The method may also be performed without regard to level conditions, so that the laser spot is simply an extension of the longitudinal axis of the pipe or other elongated member.

Another method of using the laser alignment tool may comprise: activating the laser emitter so that a laser spot is projected onto a target object; positioning the laser alignment tool near the end of the elongated member such that the laser beam is projected along the axis of the elongated member, positioning the elongated member so that the second level indicates that the central axis is vertical, and marking the spot on the target object.

There has thus been outlined, rather broadly, some of the embodiments of the laser alignment tool in order that the detailed description thereof may be better understood, and in order that the present contribution to the art may be better appreciated. There are additional embodiments of the laser alignment tool that will be described hereinafter and that will form the subject matter of the claims appended hereto. In this respect, before explaining at least one embodiment of the laser alignment tool in detail, it is to be understood that the laser alignment tool is not limited in its application to the details of construction or to the arrangements of the components set forth in the following description or illustrated in the drawings. The laser alignment tool is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a laser alignment tool body in accordance with an example embodiment.

FIG. 2 is another perspective view of a laser alignment tool in accordance with an example embodiment.

FIG. 3 is a rear perspective view of a laser alignment tool in accordance with an example embodiment.

FIG. 4 is a rear view of a laser alignment tool in accordance with an example embodiment.

FIG. 5 is a side view of a laser alignment tool in accordance with an example embodiment.

FIG. 6 is a front view of a laser alignment tool body in accordance with an example embodiment.

FIG. 7 is a side view of a laser alignment tool in use in a horizontal orientation in accordance with an example embodiment.

FIG. 8 is another side view of a laser alignment tool in use in a horizontal orientation in accordance with an example embodiment.

FIG. 9 is a side view of a laser alignment tool in use in a vertical orientation in accordance with an example embodiment.

FIG. 10 is a rear view of a laser alignment tool in accordance with another example embodiment.

FIG. 11 is a perspective view of a laser alignment tool in accordance with another example embodiment.

### DETAILED DESCRIPTION

### A. Overview.

An example laser alignment tool 100 generally comprises a tool body 110 having a rear surface 116 that is normal to a central axis 127 of the laser alignment tool, a laser emitter 124 mounted on the tool body such that the laser emitter projects a laser beam along the central axis 127 of the laser alignment tool, and a centering element 114 or 115 on the tool body 110 adapted to position the laser alignment tool on an end of an elongated member 130 such that an axis of the elongated member is substantially coaxial with the central axis 127 of the laser alignment tool 100.

In some embodiments, the centering element comprises a ring or a plurality of rings 114a-114d, and the elongated member 130 may be a pipe, beam, stud, or any element for which alignment may be desired. If the embodiment includes a plurality of rings 114a-114d, they may be concentric rings and may each further be sized and shaped so that the end of a standard pipe (of various sizes) or standard pipe fitting 136, fits on one of the rings 114. Further, the rings may be sized so that different sized standard pipes (such as a standard-size PVC pipe or metal pipe) or fittings fit on the outside or on the inside of a ring. The concentric rings 114a-114d may be spaced apart from each other, and may extend away from the rear surface 116 of the tool body 110, and be normal to the rear surface 116.

The rear surface 116 of the tool body 110 may be adapted to contact a flat surface 132 of the elongated member 130, which may be apipe, or fitting 136 that is near the end 134 of the pipe 130 such that the central axis 127 of the laser alignment tool 100 is normal to the flat surface 132 of the elongated member 130. However, contact is not necessary, as a close fit between the centering elements and the elongated member 130 or fitting 136 (e.g., a fitting 136 mounted on the end of the elongated member 130) will also cause the central axis 127 of the laser alignment tool 100 to be aligned with the longitudinal axis 127 of the elongated member. Accordingly, both the laser beam and the central axis 127 of the laser alignment tool 100 will be aligned with the longitudinal axis 127 of the elongated member 130.

In another embodiment of the laser alignment tool, the centering element can comprise an annular groove 115, or a plurality of concentric annular grooves 115a-115d formed as part of the rear surface of the tool body 110. In other words, each annular groove 115 may have a bottom surface that is parallel to the rear portion of the tool body 110, so that, for alignment purposes, both the rear portion of the tool body and the bottom of one or more annular rings comprise a part of rear surface 116, and each such part of the rear surface is in a plane that is perpendicular to the central axis 127 of the tool.

When an elongated member 130 is positioned so that its terminal end or flat surface 132 rests on the rear surface 116 of the tool 100, and when the tool is centered on the elongated member 130 by an annular groove 115 or other centering element, the axis of the elongated member 130 will be aligned with the axis 127 of the tool. As noted, the elongated member 130 may be a pipe, and the flat surface 132 of the pipe (at its end) may be annular and in a plane that is perpendicular to the longitudinal axis of the pipe. Notably, the tool can be used not just with pipes, but with other elongated members. For example, the tool can readily be made to be centered on a 2×4 or other structural element, so that an alignment beam will be projected along that member's axis for alignment purposes.

The laser alignment tool 100 may also comprise a first level 120 mounted on the tool body 110 to indicate a level condition when the central axis 127 is horizontal. Further, the tool 100 may also include a second level 122 mounted on the tool body 110 to indicate a level condition when the central axis 127 is vertical.

### B. Tool Body.

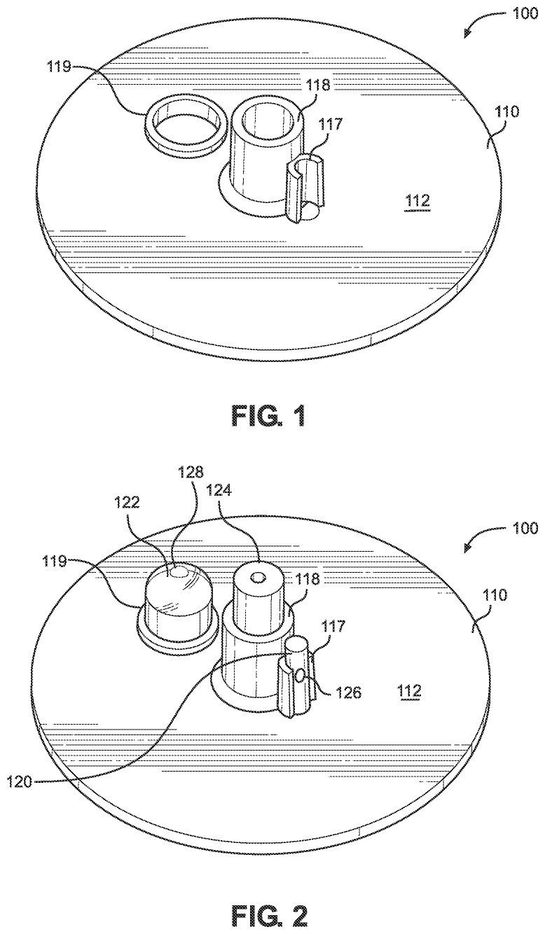

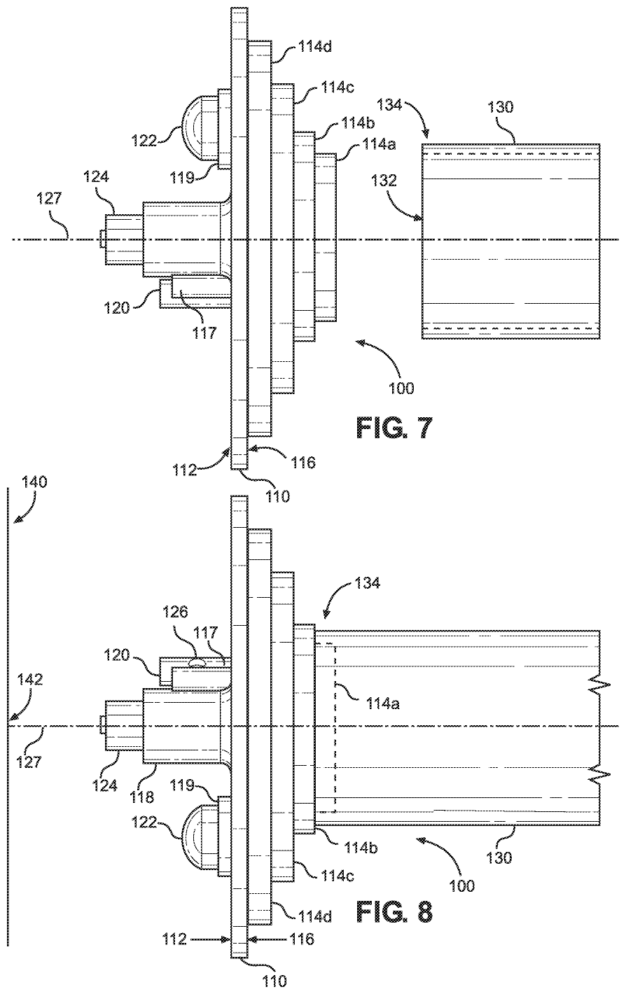

As shown in FIGS. 1-10, the laser alignment tool 100 comprises a tool body 110. As also shown, FIGS. 1 and 2 and 5-10 best illustrate the top or front of the tool body 110. From this view, the tool body 110 can be seen as generally disc-shaped, although other shapes are possible. The body has a front surface 112 and a rear surface 116, which are generally planar and normal to the central axis 127 of the tool, as shown, for example, in FIGS. 7-9.

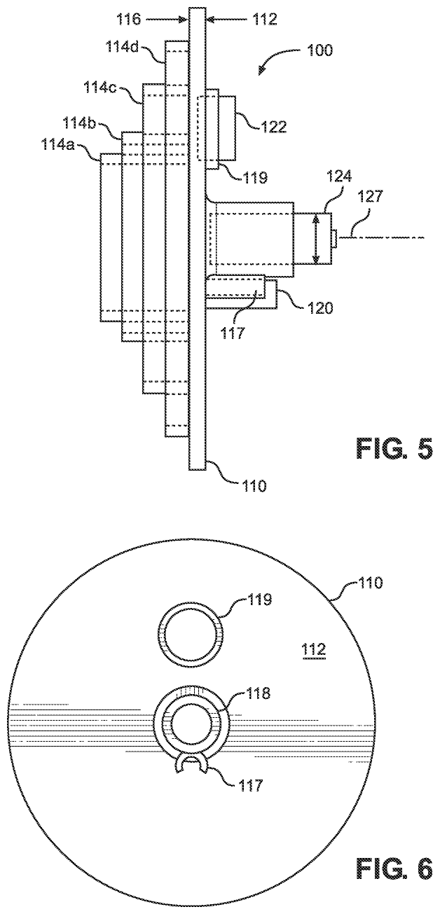

The tool body may be formed of a single piece of material, or it may be comprised of multiple parts which are then assembled to form a body substantially as shown in the figures, without affecting the functionality of the tool 100. The tool body 110 is rigid, and may be made of plastic, metal, wood, or other material. The top of the tool body will generally include a holder 118, sized and shaped to securely hold a laser emitter 124, such that the laser beam from the emitter 124 is projected along the central axis 127 of the laser alignment tool, as shown, for example, in FIGS. 5 and 7-9. The laser holder 118 may be adapted to hold the laser emitter 124 either due to an interference fit, or alternatively, the laser emitter may be mechanically or adhesively secured in the holder 118, such as by screws, tabs, interlocking elements, or glue (not shown).

The tool body may also include two additional mounts 117 and 119, for mounting or positioning levels 120 and 122, respectively, on the tool body 110. The levels may be on the top/front of the tool body 110 as shown in FIG. 2, so that they may be viewed and used to align the tool in a horizontal or vertical position when the tool 100 is positioned on an elongated member 130, which will generally be at the rear side, opposite the side of the tool body with the laser emitter 124 and the levels 122, 120 mounted on the body 110. The holder 118 and mounts 117 and 119 are made so that the levels will be either aligned with the central axis 127, or be normal to it. Specifically, mount 117 is aligned with central axis 127, so that the longitudinal axis of rod-shaped level (a first level) 120 is parallel to the axis 127. Similarly, the mount 119 is sized and shaped so that a circular, horizontal second level 122 will contact surface 112, or will otherwise be aligned with it as shown in FIGS. 8 & 9, for example, so that when the central axis 127 is vertical, the level 122 (e.g., bubble 128) will indicate that the tool 100 is horizontal, and correspondingly, surfaces 112 and 116 are horizontal as well.

### C. Centering Elements.

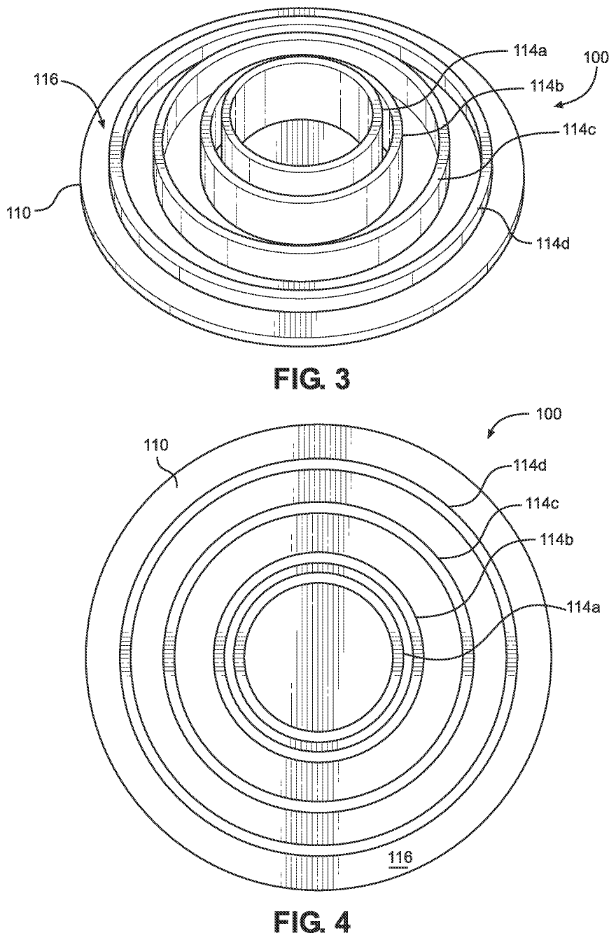

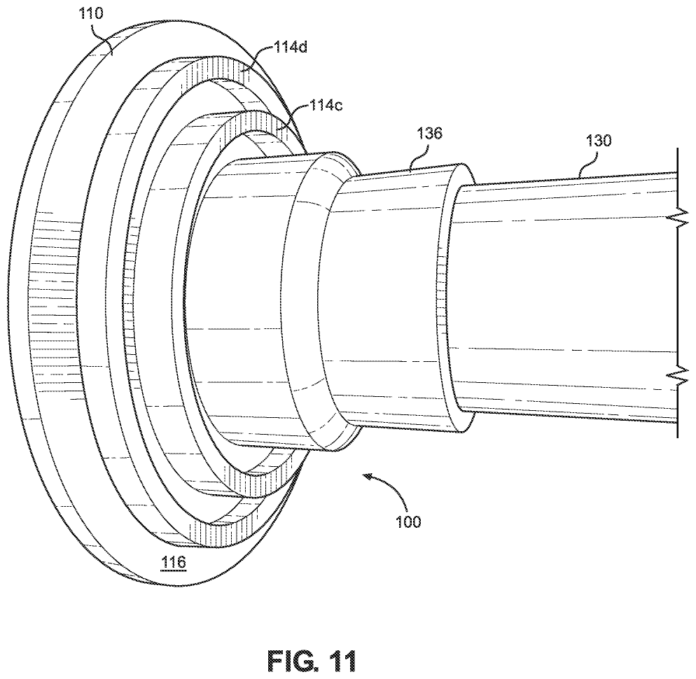

As shown in FIGS. 3-5 and 7-11, the alignment tool 100 may include one or more centering elements, which are generally formed in or mounted on the tool body 110. In one possible embodiment, the centering elements may comprise one or more concentric rings 114a-114d, as shown in FIGS. 3-5 and 7-9 and 11. These concentric rings extend outward from the rear surface 116 of the tool body 110, and are each centered on axis 127. Further, the rings may be sized so that a standard pipe, such as a PVC or metal pipe, will fit over the ring (i.e., with the ring inside of the pipe, as shown in FIGS. 7-8), or so that a standard size pipe fits within a ring. In this way, the laser alignment tool can be used with a variety of pipes or other elongated members 130. Alternatively, the rings may have the same outside and/or inside diameter of standard pipes, so that an adapter 136 will fit on both the end of a standard pipe and on one of the concentric rings 114a-114d, as shown for example in FIG. 11. In this case, an adapter or fitting 136 may be secured to the end of elongated member 130, such as by standard adhesive methods or other methods of joining PVC pipes. Doing so may result in better alignment, in cases where an end of an elongated member 130 is cut to a rough length and is not perfectly square. A fitting 136 will still fit snugly onto elongated member 130, as shown, and will have a finished end that may rest flat against surface 116 and fits tightly on ring 114b in the example shown. It is not necessary for an elongated member 130 or a fitting 136 to rest on, or be positioned on, the centering elements 114 and surface 116, as one or the other can result in proper positioning of the laser alignment tool 100 on the elongated member 130.

As shown in FIG. 8, ring 114a holds the tool 100 in alignment with elongated member 130. The ring 114a, or any of the other concentric rings, may also be sized so that a pipe or fitting fits securely but removably on or within the ring, so that the relative position of the tool on a pipe shown for example in FIG. 8 will be maintained in any orientation—even with the pipe being vertical and the tool on the lower side of the pipe. Accordingly, the tool may be used in “hands free” mode to mark a spot on an object as discussed further below. The longitudinal axis of the elongated member 130 is aligned with the central axis when the laser alignment tool is positioned relative to the end of the elongated member by one of the plurality of concentric centering rings. Note that the laser alignment tool can be positioned relative to the end of elongated member 130 by direct placement on the elongated member 130, or by positioning on a fitting 136.

In another embodiment, the centering elements may comprise one or more annular grooves 115a-115d in the rear of tool body 110, as shown in FIG. 10. As with other embodiments, the annular grooves are sized so that the ends of a number of standard PVC or metal pipes or fittings will fit in the grooves in order to hold the tool in position on the end of a pipe or an adapter 136 on the end of the pipe. In addition, the annular grooves 115 may be sized to closely match the inside diameter, outside diameter, or both, of a standard pipe or other elongated member 130, or a fitting 136, so that the tool 100 remains firmly but removably on the pipe, elongated member 130, or fitting 136 in any orientation.

As discussed above, the alignment tool can be used with other structures than pipes, such as standard or non-standard construction materials, like 2×4 lumber, etc. In such cases, the centering elements can be made to fit on whatever structure is to be aligned, so that the laser emitter 124 projects its beam along an axis of the structural item, such as an axis in the center or an edge of the 2×4. In the case of a 2×4 or other element, the centering element could be a rectangular band or channel that receives the 2×4, and other arrangements such as clamps, spikes, etc., are also possible.

In any embodiment, the centering elements 114, 115 help position an elongated member 130 on the tool. In addition to the centering elements, the end 134 of the elongated member also serves to align the tool and the elongated member. Specifically, if the elongated member 130 is a pipe, it will have a flat, annular surface 132, such that when the tool is firmly placed on the pipe, the flat surface 132 will contact rear surface 116 of the laser alignment tool 100, which helps ensure that axis of the pipe and the tool axis 127 are aligned with each other, as shown in FIGS. 7-9.

### D. Operation of a Preferred Embodiment.

In use, the laser alignment tool can project a laser beam along the axis of a pipe or any other elongated member, so that a user can either determine where the center of the pipe will meet a target object, or adjust the position of the pipe or member so that, when extended, the extended part will intersect the target object in a desired location. As one example, the tool 100 may be used to project a laser spot 142 onto a target object 140, such as a wall or ceiling, so that, for example, a hole can be cut or drilled in the proper location before the pipe is extended by joining a length of pipe onto an existing pipe end.

Other uses are also possible. For example, the laser alignment tool 100 could be used to accurately determine where another pipe that will ultimately connect with a first pipe on which the tool is mounted, should be placed, even at a great distance from the first pipe, so that work on another part of a project can proceed without waiting for intermediate pipes to be installed on the first pipe to see where the extension of the first pipe will be.

To use the tool, a user will typically position the tool onto the end of a member or pipe, as shown in FIGS. 7, 8 and 11, and will press or place the tool onto the end 134 of the elongated member, pipe, or fitting if necessary to ensure alignment. Next, the laser emitter 124 will be activated, so that a laser beam is projected along the axis 127 of the tool 100 and the elongated member 130. If the elongated member 130 is horizontal and a horizontal orientation is desired, the tool 100 may be positioned on the end 134 as shown in FIG. 8, with first level 120 in a horizontal position at the top of the tool, such that bubble 126 or another type of indication lets the user determine that the axis of the elongated member is horizontal, and adjust it so that it is, if needed. Thus, the tool accurately projects a laser spot 142 onto a target object 140, such as a wall or ceiling, which can then be marked by the user to indicate where the member 130, or another member or pipe attached to it, will meet the object.

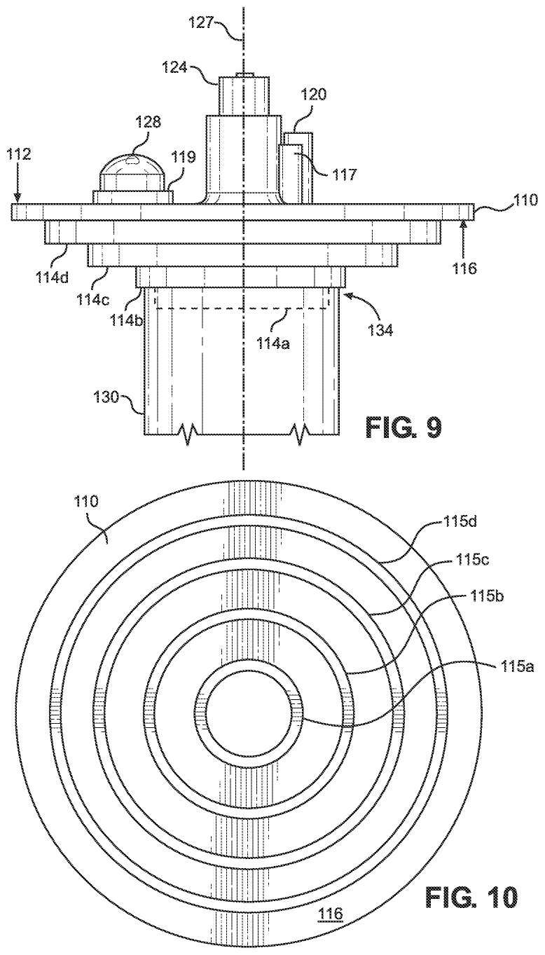

If the tool is used on a pipe or other elongated member 130 that is vertical, the tool and pipe can be oriented as shown in FIG. 9. In such case, the pipe can be adjusted if necessary so that the bubble 128 (or other indication) of second level 122 indicates that the tool 100 and tool body 110 is horizontal, and more specifically, that rear surface 116 and front surface 112 are horizontal. When those surfaces are horizontal, the axis 127 of both the tool 100 and the elongated member 130 will be vertical, so that a spot 142 will be projected onto a target object 140 directly above the center of the elongated member 130. The tool can also be used to mark a spot 142 directly below an elongated member 130, in which case the level may be placed on the rear surface 116 of the tool, or be oriented differently than shown in FIG. 9.

It is also possible, and may in some instances be desirable, to use the tool 100 without regard to whether it is horizontal or vertical. As an example, often a pipe used to carry drain water will have a slope, and in those cases the laser alignment tool 100 can be used by simply positioning it on the end of a pipe or a fitting without regard to levels. Further, the laser alignment tool 100 can be made without levels and still perform as described here.

Typically, if the elongated member 130 is a pipe, the pipe will have a finished end that is a flat, annular surface that lies in a plane that is perpendicular to the longitudinal axis 127 of the pipe. This construction is shown, for example, in FIG. 7, where surface 132 is an annular, flat surface near the end 134 of the pipe. In addition to the centering elements, this characteristic helps ensure that the axis of the pipe is aligned and thus coaxial with the central axis of the laser alignment tool 100. In use then, a user simply presses or forces the tool 100 onto the elongated member so that the flat surface 132 makes good contact with rear surface 116 of tool body 110 before marking the spot 142. As also discussed above, the tool may be used in the same manner, but with a fitting 136 on the end of a pipe or other elongated member 130, wherein the tool 100 has centering elements sized to fit securely on fittings 136 of various sizes, such as standard sized fittings, couplers, etc.

Unless otherwise defined, all technical and scientific terms used herein have the same meaning as commonly understood by one of ordinary skill in the art to which this invention belongs. Although methods and materials similar to or equivalent to those described herein can be used in the practice or testing of the laser alignment tool, suitable methods and materials are described above. All patent applications, patents, and printed publications cited herein are incorporated herein by reference in the entireties, except for any definitions, subject matter disclaimers or disavowals, and except to the extent that the incorporated material is inconsistent with the express disclosure herein, in which case the language in this disclosure controls.

The laser alignment tool may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A laser alignment tool for projecting a laser spot onto a target object, comprising:
a tool body having a rear surface that is normal to a central axis of the laser alignment tool;
a laser emitter mounted on the tool body such that the laser emitter projects a laser beam along the central axis of the laser alignment tool; and
a centering element on the tool body adapted to securely position the laser alignment tool near an end of an elongated member such that an axis of the elongated member is substantially coaxial with the central axis of the laser alignment tool.

2. The laser alignment tool of claim 1, wherein the centering element comprises a ring.

3. The laser alignment tool of claim 2, wherein the ring is sized and shaped so that the end of the elongated member fits inside the ring.

4. The laser alignment tool of claim 2, wherein the elongated member comprises a pipe, and wherein the ring is sized and shaped so that the end of the pipe fits over the ring.

5. The laser alignment tool of claim 1, wherein the centering element comprises an annular groove.

6. The laser alignment tool of claim 1, wherein the rear surface is adapted to contact a flat surface of the elongated member that is near the end of the elongated member such that the central axis of the laser alignment tool is normal to the flat surface.

7. The laser alignment tool of claim 1, wherein the centering element is adapted to be positioned on a fitting on the end of the elongated member.

8. The laser alignment tool of claim 1, wherein the centering element comprises a plurality of concentric centering elements, wherein each centering element is adapted for use with a different sized elongated member.

9. The laser alignment tool of claim 8, wherein the plurality of concentric centering elements comprise a plurality of rings extending away from the rear surface.

10. The laser alignment tool of claim 8, wherein the plurality of concentric centering elements comprise a plurality of annular grooves in the rear surface.

11. The laser alignment tool of claim 1, further comprising a first level mounted on the tool body to indicate a level condition when the central axis is horizontal.

12. A method of using the laser alignment tool of claim 11, comprising:
activating the laser emitter;
positioning the laser alignment tool on the end of the elongated member such that the laser beam is projected along the axis of the elongated member;
positioning the elongated member so that the first level indicates that the central axis is horizontal; and
marking the target object where the laser spot illuminates it.

13. The laser alignment tool of claim 11, further comprising a second level mounted on the tool body to indicate a level condition when the central axis is vertical.

14. A method of using the laser alignment tool of claim 13, comprising:
activating the laser emitter;
positioning the laser alignment tool on the end of the elongated member such that the laser beam is projected along the axis of the elongated member;
positioning the elongated member so that the second level indicates that the central axis is vertical; and
marking the target object where the laser spot illuminates it.

15. The laser alignment tool of claim 1, further comprising a level mounted on the tool body to indicate a level condition when the central axis is vertical.

16. A method of using the laser alignment tool of claim 1, comprising:
activating the laser emitter;
positioning the laser alignment tool on the end of the elongated member such that the laser beam is projected along the axis of the elongated member; and
marking the target object where the laser spot illuminates it.

17. The method of using the laser alignment tool of claim 16, wherein positioning the laser alignment tool comprises contacting the rear surface of the laser alignment tool with a flat surface of the elongated member that is near the end of the elongated member.

18. A laser alignment tool for projecting a laser spot onto a target object, comprising:
a tool body having a rear surface that is normal to a central axis of the laser alignment tool;
a laser emitter mounted on the tool body such that the laser emitter projects a laser beam along the central axis of the laser alignment tool;
a plurality of concentric centering rings on the tool body, wherein each of the plurality of concentric centering rings is adapted to hold the laser alignment tool near an end of an elongated member;
a first level mounted on the tool body to indicate a level condition when the central axis is horizontal; and
a second level mounted on the tool body to indicate a level condition when the central axis is vertical;
wherein a longitudinal axis of the elongated member is aligned with the central axis when the laser alignment tool is positioned relative to the end of the elongated member by one of the plurality of concentric centering rings.

19. A laser alignment tool for projecting a laser spot onto a target object, comprising:
a tool body having a rear surface that is normal to a central axis of the laser alignment tool;
a laser emitter mounted on the tool body such that the laser emitter projects a laser beam along the central axis of the laser alignment tool;
a plurality of concentric annular grooves on the rear surface of the tool body, wherein each of the plurality of concentric annular grooves is adapted to position the laser alignment tool on an end of a pipe;
a first level mounted on the tool body to indicate a level condition when the central axis is horizontal; and
a second level mounted on the tool body to indicate a level condition when the central axis is vertical;
wherein a longitudinal axis of the pipe is aligned with the central axis when the flat surface of the pipe is against the rear surface of the tool body and when the end of the pipe is in one of the plurality of concentric annular grooves.
